(19) United States
(12) Patent Application Publication
(10) Pub. No.: US 2017/0062115 A1
(43) Pub. Date: Mar. 2, 2017

(54) COIL COMPONENT ASSEMBLY AND COIL COMPONENT

(71) Applicant: SAMSUNG ELECTRO-MECHANICS CO., LTD., Suwon-si (KR)

(72) Inventors: Byung Soo KANG, Suwon-si (KR); Eo Jin CHOI, Suwon-si (KR); Byeong Cheol MOON, Suwon-si (KR)

(21) Appl. No.: 15/070,680

(22) Filed: Mar. 15, 2016

(30) Foreign Application Priority Data
Aug. 24, 2015 (KR) 10-2015-0119024

(51) Int. Cl. H01F 27/02; H01F 41/02; H01F 17/04

(52) U.S. Cl. CPC H01F 27/027; H01F 17/04; H01F 41/0246; H01F 2017/048

(57) ABSTRACT

A coil component assembly includes a magnetic mold having a plurality of machined spaces having open top surfaces, coils disposed in the plurality of machined spaces, respectively, and a magnetic material covering the magnetic mold and filling the machined spaces around the coils.

### CROSS-REFERENCE TO RELATED APPLICATION

This application claims the benefit of priority to Korean Patent Application No. 10-2015-0119024, filed on Aug. 24, 2015 with the Korean Intellectual Property Office, the entirety of which is incorporated herein by reference.

### TECHNICAL FIELD

The present disclosure relates to a coil component assembly and a coil component.

### BACKGROUND

An inductor, a coil component, is a representative passive element configuring an electronic circuit together with a resistor and a capacitor so as to remove noise therefrom. For example, a power inductor may be used in a power supply circuit or in a converter circuit in which a high current flows.

A wire-wound coil component is widely used as the coil component, as it has a relatively simple a manufacturing method. Such a wire-wound coil component is generally manufactured using a mold technique in which a wire-wound coil is disposed in a mold, a sealing material is filled in the mold, and the molded wire-wound coil is then cured.

### SUMMARY

An aspect of the present disclosure provides a coil component assembly which may be used to manufacture a coil component which is easily mass-produced and has excellent price competitiveness.

An aspect of the present disclosure also provides a coil component having excellent coil positioning precision.

According to an aspect of the present disclosure, a coil component may be manufactured by a novel technique using a magnetic mold having at least machined spaces in which coils may be stably disposed.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view schematically illustrating a coil component assembly according to an exemplary embodiment so that machined spaces of the coil component assembly can be seen;

FIG. 2 is a view illustrating a magnetic mold and the machined spaces;

FIGS. 3A through 3C are views illustrating various examples of the machined spaces of the magnetic mold;

FIG. 4 is a schematic perspective view of a coil component according to an exemplary embodiment;

FIG. 5 is a cross-sectional view taken along a surface A-A′ of the coil component of FIG. 4; and

FIGS. 6A through 6D are views sequentially illustrating processes of manufacturing a coil component according to an exemplary embodiment.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

Coil Component Assembly

Hereinafter, a coil component assembly according to an exemplary embodiment, particularly, a wire-wound coil component assembly will be described. However, the present disclosure is not necessarily limited thereto.

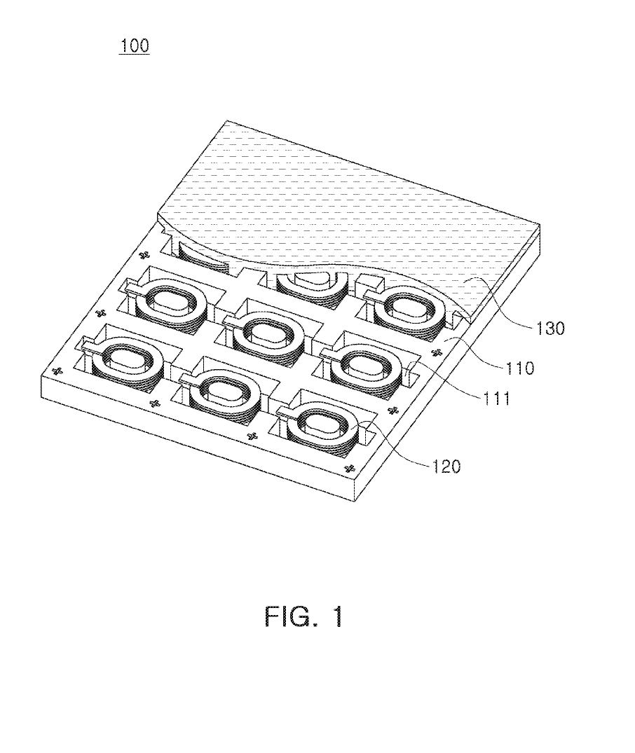

FIG. 1 is a perspective view schematically illustrating a coil component assembly 100 according to an exemplary embodiment so that machined spaces 111 of the coil component assembly 100 can be seen.

Referring to FIG. 1, the coil component assembly 100 according to an exemplary embodiment may include a magnetic mold 110, a plurality of coils 120, and a magnetic material 130.

The magnetic mold 110 may form a portion of an outer surface of the coil component assembly 100. The magnetic mold 110 may include magnetic powder particles, and may be formed of a thermosetting resin such as an epoxy, polyimide, or the like interposed between the magnetic powder particles.

As a detailed example, the magnetic powder particles may be ferrite powder particles or metallic magnetic powder particles exhibiting magnetic characteristics. In addition, the ferrite powder particles may be one or more selected from a group consisting of a Mn—Zn based ferrite powder, a Ni—Zn based ferrite powder, a Ni—Zn—Cu based ferrite powder, a Mn—Mg based ferrite powder, a Ba based ferrite powder, and a Li based ferrite powder, and the metallic magnetic powder may include one or more selected from a group consisting of iron (Fe), silicon (Si), chromium (Cr), aluminum (Al), niobium (Nb), phosphorus (P), boron (B), carbon (C), cobalt (Co), and nickel (Ni), but is not necessarily limited thereto.

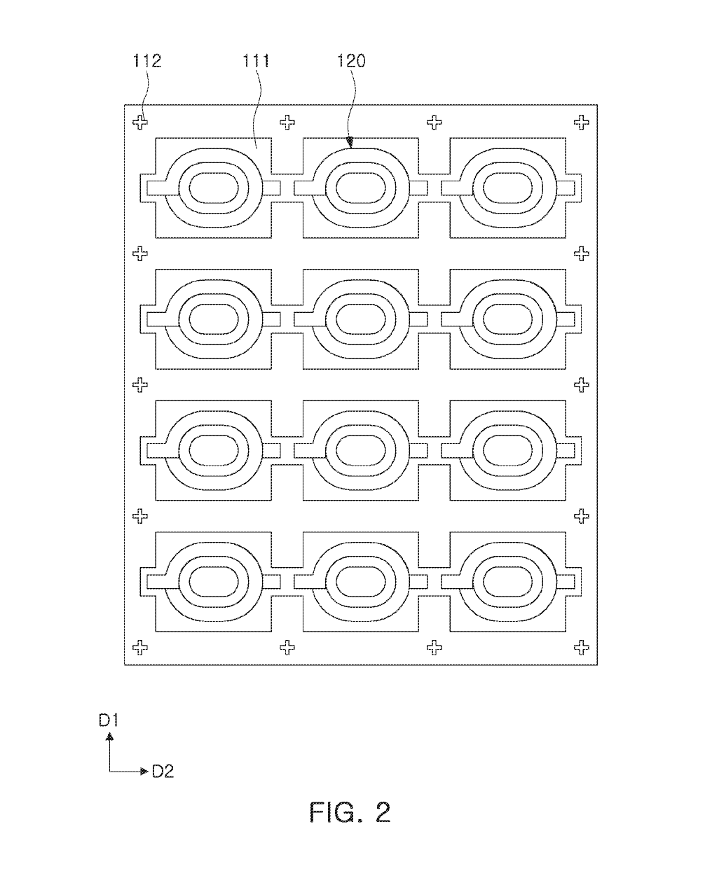

FIG. 2 is a view illustrating the magnetic mold 110 and the machined spaces 111.

Referring to FIG. 2, the magnetic mold 110 may have a plurality of machined spaces 111 having open top surfaces, and the coils 120 may be respectively disposed in the plurality of machined spaces 111. As the coils 120 are disposed on the magnetic mold 110 having the plurality of machined spaces 111 having open top surfaces, the cost of a mold replacement may be significantly reduced as compared to an existing mold technique in which a wire-wound coil is disposed in a mold, a sealing material is filled in the mold, and the mold is then cured, thereby having excellent price competitiveness and allowing mass-production to be easily implemented.

The plurality of machined spaces 111 may be regularly formed in a first direction D1 and a second direction D2 which is offset from the first direction by an angle of 90°, within a plane parallel to the top surface of the magnetic mold 110. In this case, dicing keys may be imprinted on boundary lines between the plurality of machined spaces 111. In this case, positioning precision of the coil may be significantly improved, and mass-production may be easily implemented.

The machined space 111 may be sufficiently larger than a size of the coil 120 in order to accommodate the coil 120. A region around the coil 120 of the machined space 111 may be filled with the magnetic material 130 as described below.

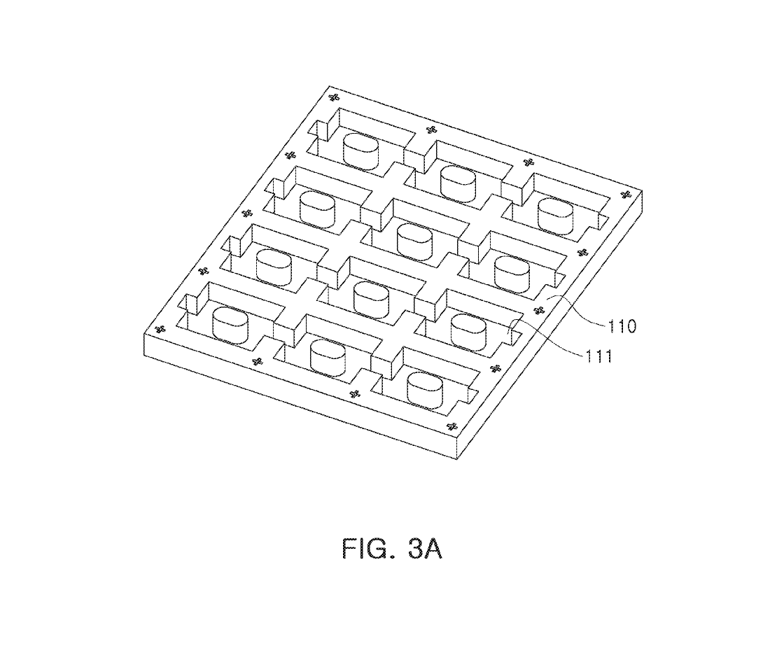

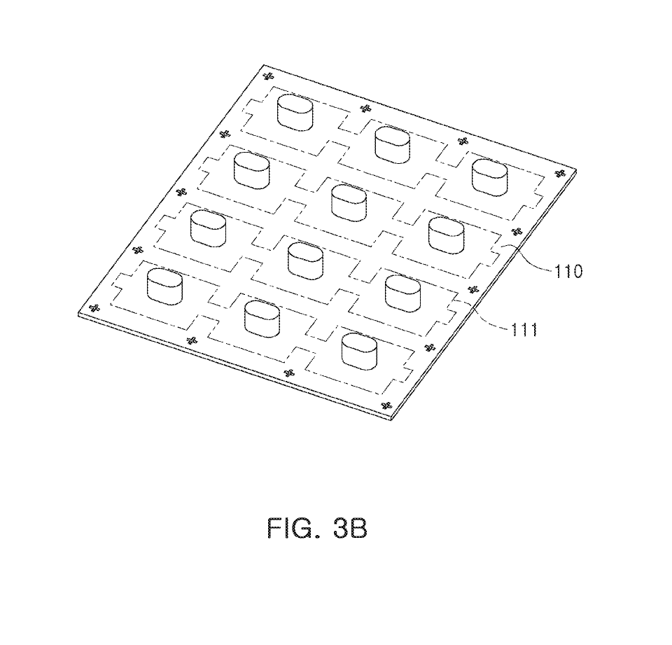

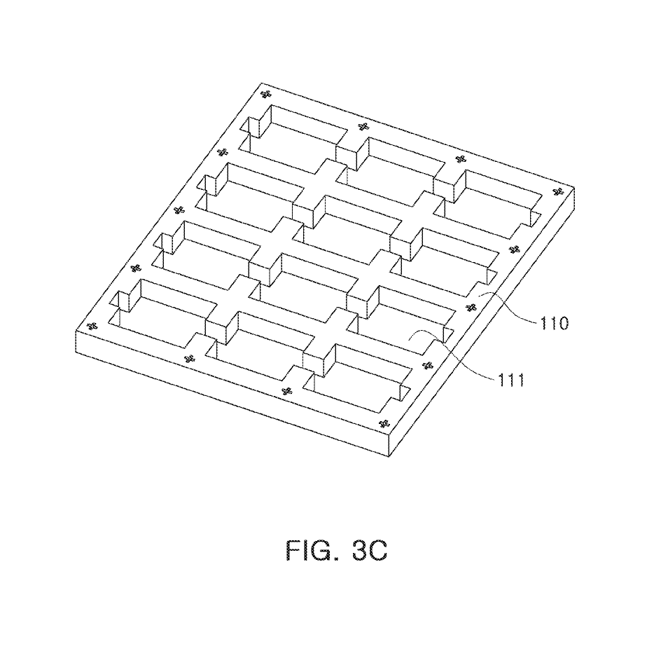

FIGS. 3A through 3C are views illustrating various examples of the machined spaces 111 of the magnetic mold 110.

As illustrated in FIGS. 3A and 3B, a central portion of the machined space 111 may be formed to protrude in a relief shape. In this case, a position of the coil 120 may be easily fixed. As a result, the coil may be more precisely positioned. Further, by increasing a filling rate of the magnetic material in a core part, performance of the coil component may be further improved.

Further, as illustrated in FIGS. 3A and 3C, the machined space 111 may be formed to be depressed in an intaglio shape. Also, in this case, the position of the coil 120 may be easily fixed. As a result, the coil may be more precisely positioned.

A planar shape of the machined space 111 is not particularly limited. For example, the planar shape of the machined space 111 may be a polygonal shape such as a quadrangular shape, or the like, or may also be an oval shape similar to a shape of the coil 120 as illustrated in FIG. 3A. However, the planar shape of the machined space 111 is not limited thereto, but may be implemented in other shapes. Further, a space in which the coil 120 is disposed and at least a portion of leading portions 122a and 122b of the coil 120 is disposed at the same time may be formed.

The coil 120 is disposed in each of the plurality of machined spaces 111 and is interposed between the magnetic mold 110 and the magnetic material 130, such that at least a portion of the coil 120 may be buried in the machined space 111.

The coil 120 may be a wire-wound coil formed by a winding technique, and may be formed of a metal wire such as copper (Cu), silver (Ag), or the like, for example, but is not necessarily limited thereto.

The coil 120 is not limited to a single wire and may also be formed of a flexible wire or two or more wires. Further, the coil 120 is not limited to as having a circular cross section shape, and may also have various known cross section shapes such as a quadrangular cross section shape, and the like.

The coil 120 may include a spiral portion 121 and a pair of leading portions 122a and 122b each led from the spiral portion 121. In this case, the pair of leading portions may be formed to be led in directions opposing each other.

The magnetic material 130 may form a portion of the external surface of the coil component assembly 100, together with the magnetic mold 110.

Similarly to the magnetic mold 110, the magnetic material 130 may include magnetic powder particles, and may be formed of a thermosetting resin such as an epoxy, polyimide, or the like interposed between the magnetic powder particles.

The magnetic material 130 may be obtained by compressing and curing magnetic sheets obtained by shaping a magnetic powder-resin composite as a sheet, on the magnetic mold 110. The magnetic material 130 may cover a top of the magnetic mold 110 and may be filled in the machined spaces 111 around the coils 120. In this case, by increasing a filling rate of the magnetic material, performance of the coil component may be further improved.

The magnetic mold 110 and the magnetic material 130 may be formed of the same material as each other. In another exemplary embodiment, the magnetic mold 110 and the magnetic material 130 may be formed of different materials. According to the present disclosure, as the magnetic mold 110 and the magnetic material 130 forming a space in which a magnetic path is formed are each separately formed, two kinds of magnetic materials may be easily used and desired characteristics of a product may be easily implemented.

Coil Component

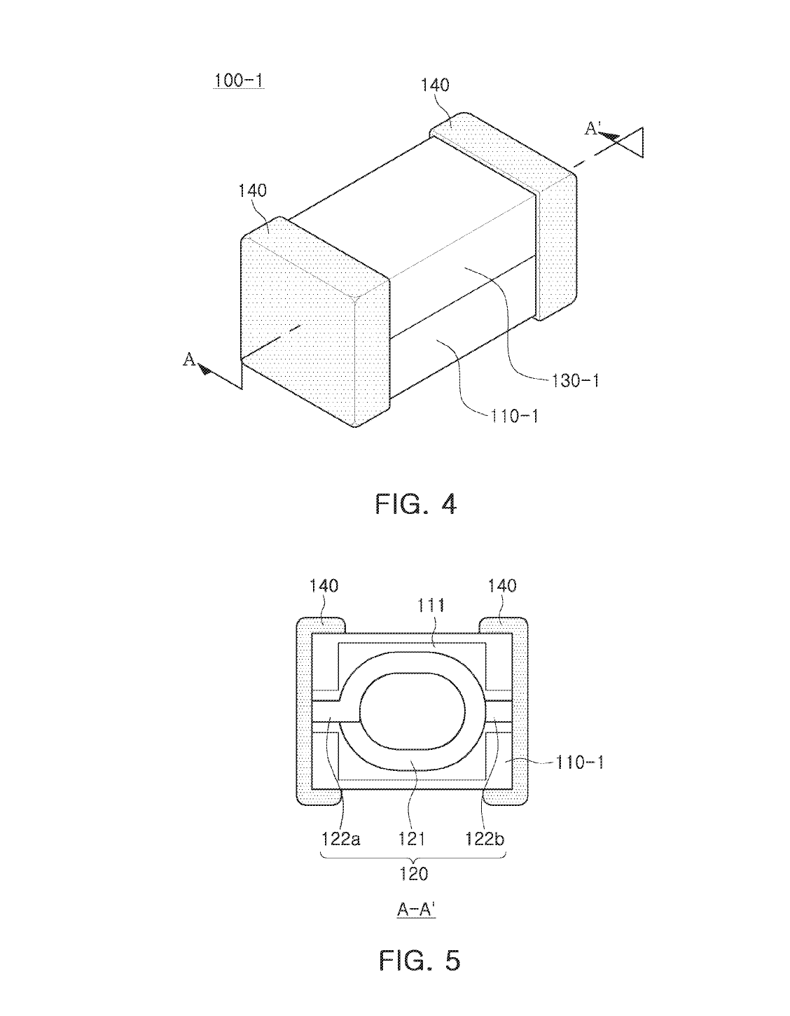

Hereinafter, a coil component according to an exemplary embodiment in the present disclosure will be described. FIG. 4 is a schematic perspective view of a coil component according to an exemplary embodiment.

Referring to FIG. 4, a coil component 100-1 according to an exemplary embodiment may include a coil (not illustrated), an upper body 130-1, and a lower body 110-1. The upper and lower bodies 130-1 and 110-1, which fill an inner portion of the coil component 100-1 and form an appearance of the coil component, may fill spaces around the coil (not illustrated).

External electrodes 140 may be formed on outer surfaces of the upper and lower bodies 130-1 and 110-1 and may be electrically connected to the coil 120 (not illustrated). Although FIG. 1 illustrates a case in which the external electrodes 140 are disposed on both end surfaces of the coil component 100-1 opposing each other, this is merely an example. A shape in which the external electrodes are formed may be variously modified depending on a kind, a design, and the need of a process of coil component 100-1. The external terminal 140 may include a metal such as silver (Ag), silver-palladium (Ag—Pd), nickel (Ni), or copper (Cu), or an alloy, and a Ni plating layer and a Sn plating layer may be selectively formed on surfaces of the external electrodes 140.

FIG. 5 is a cross-sectional view taken along a surface A-A′ of the coil component of FIG. 4.

Referring to FIG. 5, the lower body 110-1 may have the machined space 111, the coil 120 may be disposed in the machined space 111, and a region around the coil 120 of the machined space 111 may be filled with the upper body 130-1.

According to an example, the upper body 130-1 may be obtained by compressing and curing magnetic sheets obtained by shaping a magnetic powder-resin composite as a sheet, on the lower body 110-1.

Except for the above-mentioned description, a description of characteristics overlapped with those of the coil component assembly according to an exemplary embodiment described above will be omitted.

Method for Manufacturing Coil Component

Hereinafter, an example of a method for manufacturing a coil component having the structure described above will be described.

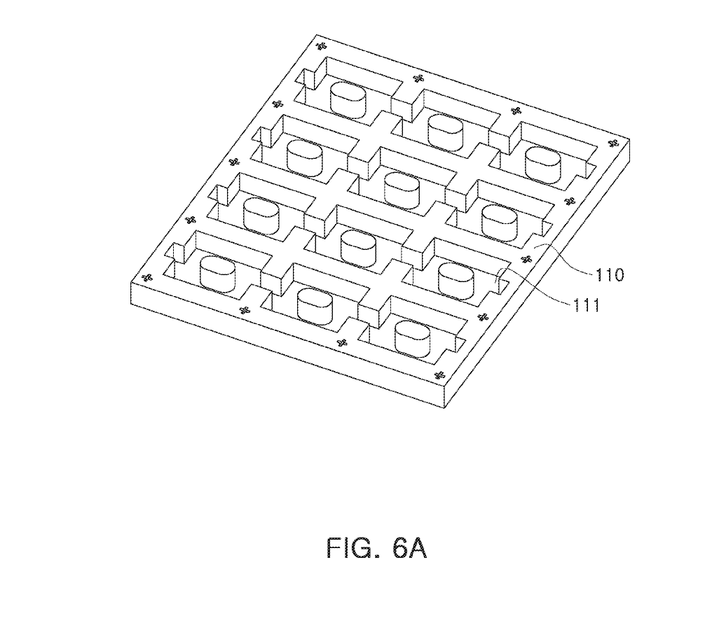

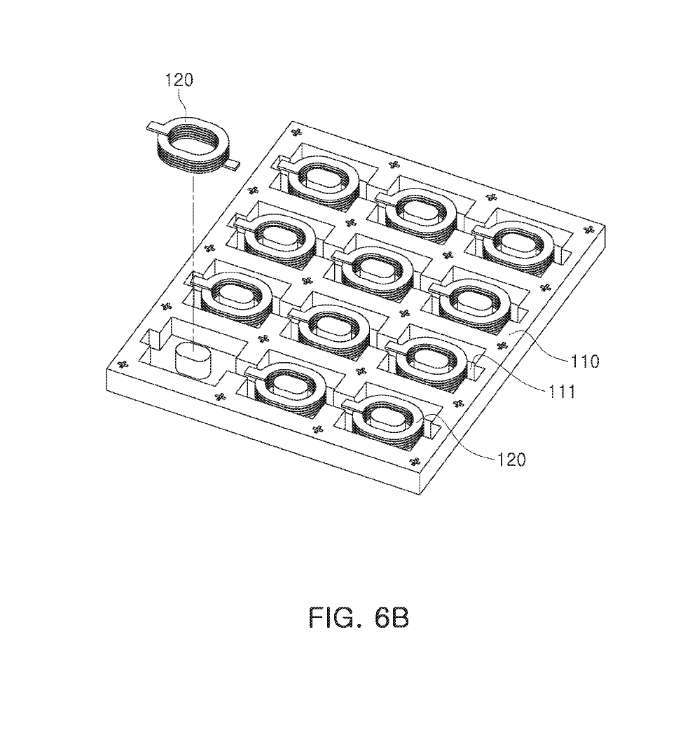

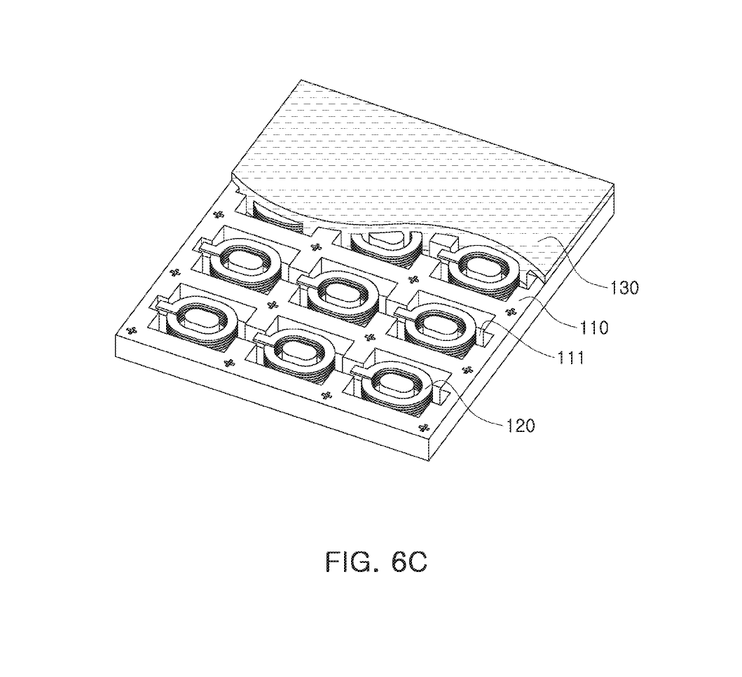

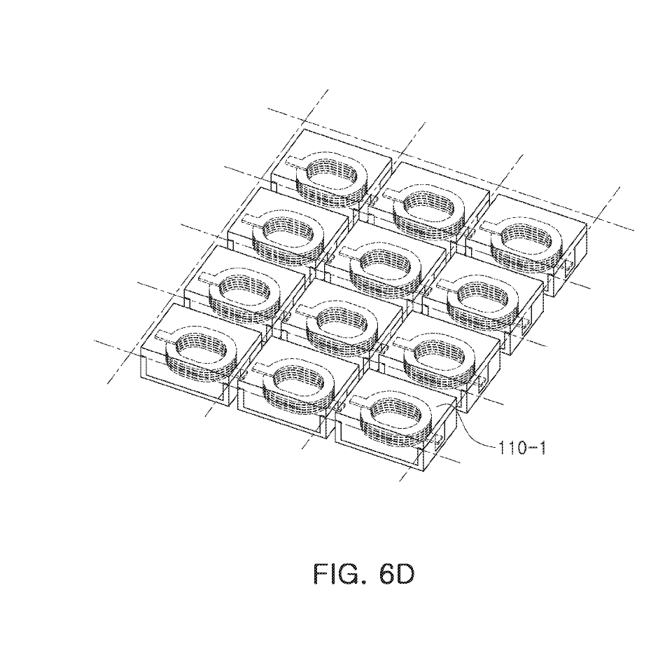

FIGS. 6A through 6D are views sequentially illustrating processes of manufacturing a coil component according to an exemplary embodiment.

First, referring to FIG. 6A, a magnetic mold 110 having a plurality of machined spaces 111 may be prepared.

According to the present disclosure, a detailed method for preparing the magnetic mold 110 having the plurality of machined spaces 111 is not particularly limited, but may include, for example, an operation of preparing magnetic sheets by shaping a magnetic resin composite as a sheet, an operation of laminating a plurality of magnetic sheets and then compressing the plurality of laminated magnetic sheets, an operation of forming a plurality of machined spaces by carving one surface of each of the plurality of compressed magnetic sheets, and an operation of curing the plurality of compressed magnetic sheets in which the plurality of machined spaces are formed. In this case, a degree of curing may be appropriately adjusted from 0% to 100% depending on a type of magnetic sheet.

Next, referring to FIG. 6B, a coil 120 may be disposed in each of the plurality of machined spaces 111. As such, as the coil 120 is seated in the machined space 111, the coil 120 may be stably mounted and the coil component 100-1 may be miniaturized.

Next, referring to FIG. 6C, a magnetic material 130 may be formed on a top of the magnetic mold 110.

According to the present disclosure, a detailed method for forming the magnetic material 130 on the top of the magnetic mold 110 is not particularly limited. However, for example, after the magnetic sheets obtained by shaping a magnetic powder-resin composite as a sheet are laminated on the top of the magnetic mold 110, the laminated magnetic sheets may be cured at a temperature higher than a curing temperature of a resin by adding the temperature and applying pressure. In this case, a region around the coil 120 of the machined space 111 may be filled with the magnetic material 130 by the applied pressure.

Next, referring to FIG. 6D, the coil component may be manufactured by dicing the magnetic mold 110 and the magnetic sheets along boundaries between the plurality of machined spaces. Here, the magnetic mold 110 and the magnetic sheets may be diced into separate components using a piece of dicing equipment, and other dicing methods such as a blade, laser, and the like may also be applied.

Except for the above-mentioned description, a description of characteristics overlapped with those of the coil component according to an exemplary embodiment described above will be omitted.

As set forth above, according to the exemplary embodiments in the present disclosure, since the coil may be stably mounted, the coil may be very precisely positioned, and since a separate mold is not required, the coil component may be easily mass-produced and may have excellent price competitiveness.

While exemplary embodiments have been shown and described above, it will be apparent to those skilled in the art that modifications and variations could be made without departing from the scope of the present invention as defined by the appended claims.

What is claimed is:

1. A coil component assembly comprising:
a magnetic mold having a plurality of machined spaces having open top surfaces;
coils disposed in the plurality of machined spaces, respectively; and
a magnetic material covering the magnetic mold and filling the machined spaces around the coils.

2. The coil component assembly of claim 1, wherein the magnetic material is obtained by compressing and curing magnetic sheets.

3. The coil component assembly of claim 1, wherein a central portion of the machined space is formed to protrude in a relief shape.

4. The coil component assembly of claim 1, wherein the machined space is formed to be depressed in an intaglio shape.

5. The coil component assembly of claim 1, wherein the coil has one or more leading portions, and
at least a portion of the leading portions is disposed in the machined space.

6. The coil component assembly of claim 1, wherein the plurality of machined spaces are regularly formed in a first direction and a second direction which is tilted from the first direction at an angle of 90°, in within a plane parallel to the top surface of the magnetic mold.

7. The coil component assembly of claim 6, wherein dicing keys are imprinted on boundary lines between the plurality of machined spaces.

8. The coil component assembly of claim 1, wherein the magnetic mold and the magnetic material are formed of different materials.

9. The coil component assembly of claim 1, wherein the magnetic mold includes magnetic powder particles and a thermosetting resin.

10. The coil component assembly of claim 9, wherein the thermosetting resin is an epoxy or a polyimide.

11. A coil component comprising:
a lower body having a machined space;
a coil disposed in the machined space; and
an upper body covering the lower body and filling the machined space around the coil.

12. The coil component of claim 11, wherein the coil has one or more leading portions, and
at least a portion of the leading portions is disposed in the machined space.

13. The coil component of claim 12, further comprising external electrodes formed on outer surfaces of the upper body and the lower body and connected to the leading portions.

14. The coil component of claim 11, wherein the lower body is formed of a different material than the upper body.

15. The coil component of claim 11, wherein the upper body includes magnetic powder particles and a thermosetting resin.

16. The coil component assembly of claim 15, wherein the thermosetting resin is an epoxy or a polyimide.

17. A method of manufacturing a coil component, the method comprising steps of:
preparing a magnetic mold having a plurality of machined spaces;
disposing a plurality of coils in the plurality of machined spaces;
forming a magnetic material on the magnetic mold; and
dicing the magnetic mold and the magnetic material to separate the plurality of coils.

18. The method of claim 17, wherein the step of preparing a magnetic mold includes steps of:
preparing magnetic sheets by shaping a magnetic resin composite as a sheet;
laminating a plurality of the magnetic sheets;
compressing the plurality of laminated magnetic sheets;
forming the plurality of machined spaces by carving one surface of each of the plurality of compressed magnetic sheets; and
curing the plurality of compressed magnetic sheets in which the plurality of machined spaces are formed.

19. The method of claim 17, wherein the magnetic material is a magnetic powder-resin composite, and the step of forming the magnetic material on the magnetic mold includes curing the magnetic material at a temperature higher than a curing temperature of the resin.
